(19) United States
(12) Patent Application Publication
(10) Pub. No.: US 2015/0237489 A1
(43) Pub. Date: Aug. 20, 2015

(54) RADIO ACCESS NETWORK APPARATUS

(71) Applicant: NTT DOCOMO, INC., Tokyo (JP)

(72) Inventors: Kenichiro Aoyagi, Tokyo (JP); Wuri Andarmawanti Hapsari, Tokyo (JP); Tooru Uchino, Tokyo (JP); Kohei Kiyoshima, Tokyo (JP)

(73) Assignee: NTT DOCOMO, INC., Tokyo (JP)

(21) Appl. No.: 14/427,508

(22) PCT Filed: Aug. 23, 2013
(86) PCT No.: PCT/JP2013/072561

§ 371 Date: Mar. 11, 2015

(30) Foreign Application Priority Data
Sep. 14, 2012 (JP) 2012-203068

(51) Int. Cl. H04W 4/22; H04H 20/72; H04W 4/06; H04H 20/59

(52) U.S. Cl. CPC H04W 4/22; H04H 20/59; H04H 20/72; H04W 4/06

(57) ABSTRACT

The present invention enables broadcasting of additional information in addition to emergency information without greatly improving a data management and processing capability in an information broadcasting node CBE or a core network apparatus. A radio access network apparatus according to the present invention includes a management unit (11) configured to manage a cell, a type of emergency information, and additional information in association with one another, and a transmission unit (13) configured to broadcast emergency information and additional information in a cell under control thereof when receiving an instruction to broadcast the emergency information, the additional information being associated with the cell and the type of the emergency information.

### TECHNICAL FIELD

The present invention relates to a radio access network apparatus.

### BACKGROUND ART

Emergency information such as ETWS (Earthquake and Tsunami Warning System) and PWS (Public Warning System) is simultaneously broadcasted over a broadcasting target area EA (Emergency Area) which is determined by an information broadcasting node CBE (Cell Broadcast Entity).

### PRIOR ART DOCUMENT

### Non-Patent Document

Non-patent document 1: 3GPP TS36.413

### SUMMARY OF THE INVENTION

In order to make detailed instruction in a small cell such as eLA (enhanced Local Area) or a cell under a HNB (Home NodeB), it is conceivable to employ an operation mode in which additional information according to a place or the like (for example, an evacuation point) is added to emergency information.

To achieve this operation mode, however, an information broadcasting node CBE or a core network device has to manage additional information for each cell. This poses a problem that the information broadcasting node CBE or the core network device needs to have a capability of managing and processing a huge amount of data.

Accordingly, the present invention has been made in view of the above problem, and an objective of the invention is to provide a radio access network apparatus capable of distributing additional information in addition to emergency information without greatly improving a capability of managing and processing data in an information broadcasting node CBE or a core network apparatus.

A first feature of the present invention is summarized as a radio access network apparatus, including: a management unit configured to manage a cell, a type of emergency information, and additional information in association with one another; and a transmission unit configured to broadcast emergency information and additional information in a cell under control thereof when receiving an instruction to broadcast emergency information, the additional information being associated with the cell and the type of the emergency information.

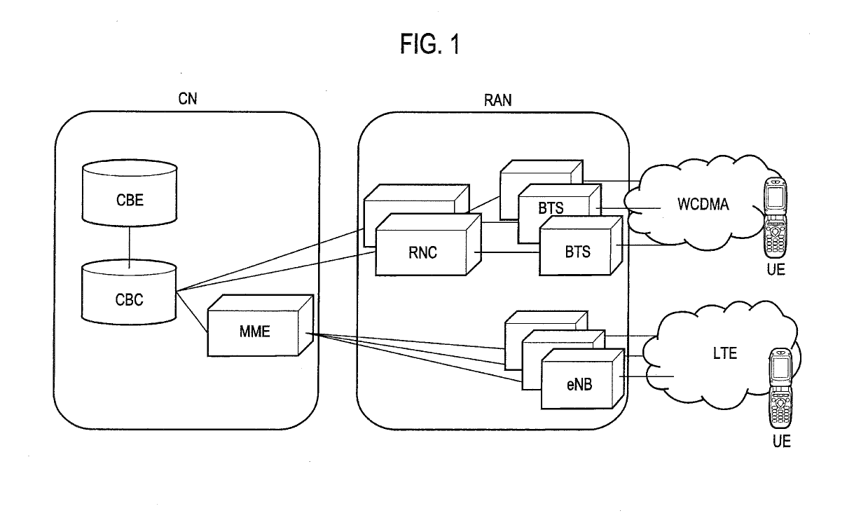

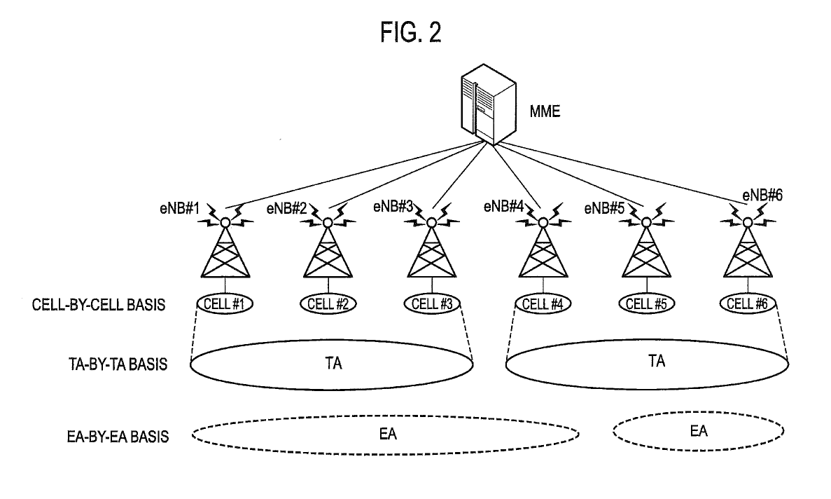

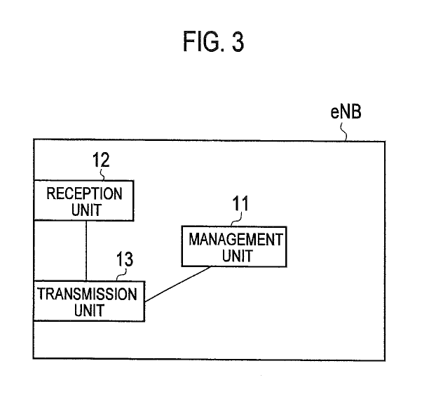

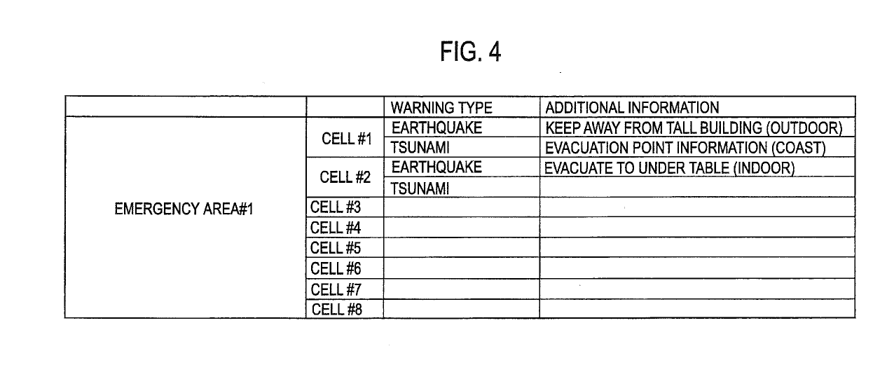

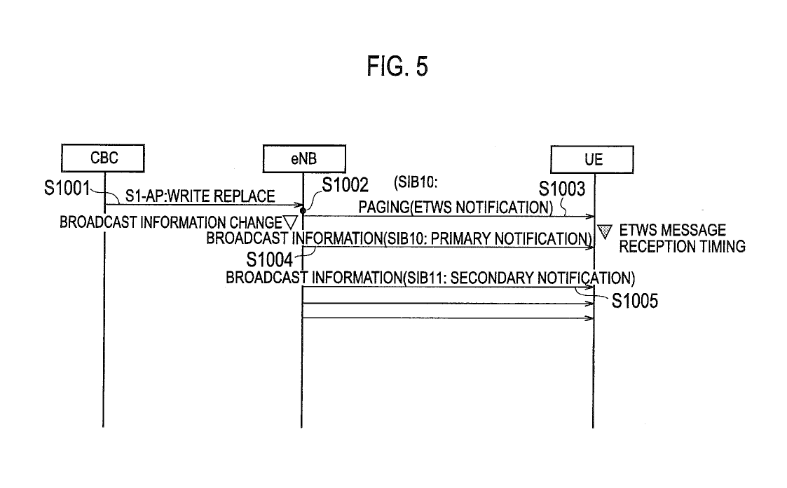

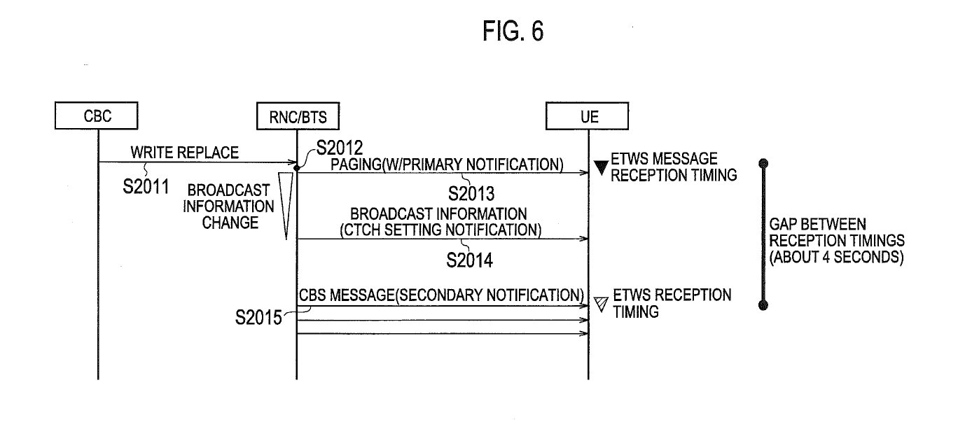

### BRIEF DESCRIPTION OF THE DRAWINGS

[FIG. 1] FIG. 1 is an overall configuration diagram of a mobile communication system according to a first embodiment of the present invention.

[FIG. 2] FIG. 2 is a diagram illustrating an example broadcasting area of emergency information under a mobile management node MME in the mobile communication system according to the first embodiment of the invention.

[FIG. 3] FIG. 3 is a functional block diagram of a radio base station eNB according to the first embodiment of the invention.

[FIG. 4] FIG. 4 is a diagram illustrating an example of information which is managed by a management unit of the radio base station eNB according to the first embodiment of the invention.

[FIG. 5] FIG. 5 is a sequence diagram illustrating an operation of the mobile communication system according to the first embodiment of the invention.

[FIG. 6] FIG. 6 is a sequence diagram illustrating an operation of the mobile communication system according to the first embodiment of the invention.

### MODE FOR CARRYING OUT THE INVENTION

### Mobile Communication System According to the First Embodiment of the Invention

Described by referring to FIGS. 1 to 6 is a mobile communication system according to a first embodiment of the present invention.

As illustrated in FIG. 1, the mobile communication system according to the embodiment includes a core network CN and a radio access network RAN.

Here, as the radio access network RAN, WCDMA (registered trade mark) (Wideband CDMA) radio access network and LTE (Long Term Evolution) radio access network are provided.

In addition, the mobile communication system according to the embodiment includes an information broadcasting node CBE, an information broadcasting station CBC (Cell Broadcast Center), and a mobile management node MME (Mobility Management Entity) as the core network apparatus.

Furthermore, the mobile communication system according to the embodiment includes multiple radio network controllers RNC (Radio Network Controller) as the WCDMA radio access network apparatus and multiple radio base stations BTS and includes multiple radio base stations eNB as the LTE radio access network apparatus.

Also, as illustrated in FIG. 2, emergency information such as ETW and PWS are broadcasted to the broadcasting target area EA which is determined by the information broadcasting node CBE.

Here, as illustrated in FIG. 2, the mobile management node MME is configured to manage a cell belonging to the broadcasting target area EA or a tracking area TA (Tracking Area).

As illustrated in FIG. 3, the radio base station eNB includes a management unit 11, a reception unit 12, and a transmission unit 13.

The management unit 11 is configured to manage at least a cell, a type of emergency information, and additional information in association with one another.

For example, as illustrated in FIG. 4, the management unit 11 manages a broadcasting target area (Emergency Area), cells (cells #1 to #8), a type of emergency information (Warning Type), and additional information in association with one another.

In the example of FIG. 4, the management unit 11 manages “Emergency Area #1” as the broadcasting target area, a cell #1, “earthquake” as an emergency type, and “keep away from tall building (outdoor)” as additional information in association with one another.

Similarly, the management unit 11 manages “Emergency Area#1” as a broadcasting target area, the cell #1, “Tsunami” as a type of emergency information, and “Evacuation point Information (Coast)” as additional information in association with one another.

Furthermore, the management unit 11 manages “Emergency Area#1” as a broadcasting target area, a cell #2, “Earthquake” as a type of emergency information, and “evacuate under table (indoor)” as additional information in association with one another.

The reception unit 12 is configured to receive various kinds of signals from the information broadcasting station CBC, the mobile management node MME, and the mobile station UE. The transmission unit 13 is configured to transmit various kinds of signals to the information broadcasting station CBC, the mobile management node MME, and the mobile station UE.

For example, the reception unit 12 receives “S1-AP: WRITE REPLACE” instructing a broadcasting of emergency information from the information broadcasting station CBC (or the mobile management node MME).

Also, in the cell corresponding to the broadcasting target area designated by the “S1-AP: WRITE REPLACE,” the transmission unit 13 broadcasts emergency information corresponding the broadcasting target area and a cell and additional information corresponding to the type of the cell and emergency information.

For example, the transmission unit 13 is configured to broadcast the emergency information and the additional information through a common channel BCH (Broadcast Channel), in other words, the broadcast information.

Here, the “S1-AP: WRITE REPLACE” may be configured to notify instruction information on whether or not additional information needs to be broadcasted.

The transmission unit 13 may determine whether or not to transmit the additional information together with the emergency information based on the instruction information.

Also, the transmission unit 13 may notify whether or not the additional information is transmitted together with the emergency information.

Furthermore, the transmission unit 13 may notify identification information of a cell in which the additional information is transmitted, together with the emergency information.

Here, a configuration similar to that of the radio base station eNB may be provided in the radio network controller RNC or the radio base station BTS.

Described hereinafter by referring to FIGS. 5 to 6 is an operation of the mobile communication system according to the embodiment.

Firstly, described by referring to FIG. 5 is an operation of distributing emergency information through the LTE radio access network in the mobile communication system according to the embodiment.

As illustrated in FIG. 5, at step S1001, the information broadcasting station CBC transmits “S1-AP: WRITE REPLACE” to the radio base station eNB in response to an instruction from the information broadcasting entity CBE.

When the “S1-AP: WRITE REPLACE” is received, at step S1002, the radio base station eNB determines whether or not to transmit additional information based on the “S1-AP: WRITE REPLACE,” and determines additional information to be transmitted when determining to transmit it.

At step S1003, the radio base station eNB transmits “ETWS Notification” indicating the activation of ETWS broadcasting to the mobile station UE in the cell belonging to the broadcasting target area by using a paging signal (Paging).

At step S1004, the radio base station eNB broadcasts “Primary Notification” which is emergency information by using SIB10 which is the broadcast information at a timing when the ETWS message is received in the cell belonging to the broadcasting target area.

After that, at step S1005, the radio base station eNB distributes “Secondary Notification” which is emergency information by using the SIB11 which is the broadcast information in the cell belonging to the broadcasting target area.

Here, the above-described additional information may be transmitted by the “Secondary Notification” or may be transmitted separately from the “Second Notification.”

Secondly, described by referring to FIG. 6 is an operation of distributing the emergency information through the WCDMA radio access network in the mobile communication system according to the embodiment.

As illustrated in FIG. 6, at step S2011, the information broadcasting station CBC transmits “WRITE REPLACE” to the radio network controller RNC in response to an instruction from the information broadcasting entity CBE.

When the “WRITE REPLACE” is received, at step S2012, the radio network controller RNC determines whether or not to transmit additional information based on the “WRITE REPLACE,” and determines the additional information when determining to transmit it.

At step S2013, the radio network controller RNC transmits “Primary Notification” which is emergency information to a mobile station UE in the cell belonging to the broadcasting target area by using a paging signal (Paging) at a timing when an ETWS message is received.

At step S2014, the radio network controller RNC broadcasts the broadcast information for notifying the setting of CTCH (Common Traffic Channel) which is a common channel in the cell belonging to the broadcasting target area.

At step S2015, the radio network controller RNC broadcasts “Secondary Notification” which is emergency information by using a CBS message which is transmitted through the CTCH in the cell belong to the broadcasting target area at a timing when the ETWS message is received.

Here, the above-described additional information may be transmitted by the “Secondary Notification” or may be transmitted separately from the “Secondary Notification.”

The mobile communication system according to the embodiment can broadcast proper additional information (such as an evacuation method and evacuation point information) on a cell-by-cell basis according to the type of emergency information such as earthquake or tsunami without increasing a load in the information broadcasting node CBE, and enables effective action supports to be provided.

The features of the present embodiment may also be expressed as follows.

A first feature of the present embodiment is summarized as a radio base station eNB and radio network controller RNC/radio base station BTS (radio access network apparatus), including: a management unit 11 configured to manage a cell, a type of emergency information, and additional information in association with one another; and a transmission unit 13 configured to broadcast emergency information and additional information in a cell under control thereof when receiving an instruction to broadcast emergency information, the additional information being associated with the cell and the type of the emergency information.

In the first feature of the present embodiment, the transmission unit 13 may broadcast the emergency information and the additional information on a common channel.

The above-described configuration can transmit the additional information together by using an existing common channel for transmitting emergency information, and thereby can avoid wasting the radio resources.

In the first feature of the present embodiment, the management unit 11 may manage a broadcasting target area in addition to the cell, the type of the emergency information, and the additional information in association with one another, and the transmission unit 13 may broadcast the emergency information and the additional information in a cell corresponding to the broadcasting target area instructed to broadcast the emergency information.

With the above-described configuration, each radio access network apparatus is caused to associate a broadcasting target area with a cell, so that a load of the mobile management node MME, the information broadcasting station CBC or the like can be reduced.

In the first feature of the present embodiment, the radio access network apparatus may include a reception unit 12 configured to receive a broadcasting instruction of the emergency information and instruction information on whether or not to broadcast the additional information. Here, the transmission unit 13 may determine whether or not to transmit the additional information based on the instruction information.

With the above-described configuration, whether or not the additional information needs to be transmitted can be controlled depending on the situation.

In the first feature of the present embodiment, the transmission unit 13 may notify whether or not the additional information is transmitted together with the emergency information.

With the above-described configuration, the mobile station UE can grasp whether or not the additional information to be received exists, and can efficiently and securely perform reception processing on the additional information.

In the first feature of the present embodiment, the transmission unit 13 may notify identification information of a cell in which the additional information is transmitted together with the emergency information.

With the above-described configuration, the mobile station UE can grasp whether or not the additional information is transmitted in a serving cell and can efficiently and securely perform the reception processing on the additional information.

Here, the foregoing operations of the mobile station UE, the radio base stations eNB/BTS, the radio network controller RNC, and the mobile management node MME may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the mobile station UE, the radio base stations eNB/BTS, the radio network controller RNC, and the mobile management node MME. Otherwise, the storage medium and the processor may be provided as discrete components inside the mobile station UE, the radio base stations eNB/BTS, the radio network controller RNC, and the mobile management node MME.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2012-203068 (filed on Sep. 14, 2012) is incorporated by reference in the present specification.

### INDUSTRIAL APPLICABILITY

As described above, the present invention can provide a radio access network apparatus capable of distributing additional information in addition to emergency information without greatly improving data management and processing capability in an information broadcasting node CBE or a core network device.

### EXPLANATION OF REFERENCE NUMERALS

CBE information broadcasting node
CBC information broadcasting station
RNC radio network controller
MME mobile management node
eNB, BTS radio base station
UE mobile station
11 management unit
12 reception unit
13 transmission unit

1. A radio access network apparatus, comprising:
a management unit configured to manage a cell, a type of emergency information, and additional information in association with one another; and
a transmission unit configured to broadcast emergency information and additional information in a cell under control thereof when receiving an instruction to broadcast emergency information, the additional information being associated with the cell and the type of the emergency information.

2. The radio access network apparatus according to claim 1, wherein the transmission unit broadcasts the emergency information and the additional information on a common channel.

3. The radio access network apparatus according to claim 1, wherein the management unit manages a broadcasting target area in addition to the cell, the type of the emergency information, and the additional information in association with one another, and the transmission unit broadcasts the emergency information and the additional information in a cell corresponding to the broadcasting target area instructed to broadcast the emergency information.

4. The radio access network apparatus according to claim 1, comprising a reception unit configured to receive a broadcasting instruction of the emergency information and instruction information on whether or not to broadcast the additional information, wherein
the transmission unit determines whether or not to transmit the additional information based on the instruction information.

5. The radio access network apparatus according to claim 4, wherein the transmission unit notifies whether or not the additional information is transmitted together with the emergency information.

6. The radio access network apparatus according to claim 4, wherein the transmission unit notifies identification information of a cell in which the additional information is transmitted together with the emergency information.
